(19) United States
(12) Patent Application Publication
(10) Pub. No.: US 2026/0329460 A1
(43) Pub. Date: Oct. 22, 2026

(54) DYNAMIC RANDOM-ACCESS MEMORY CONFIGURATIONS

(71) Applicant: Intel Products IP LLC, Santa Clara, CA (US)

(72) Inventors: Todd Andrew Hinck, Arlington, MA (US); Min Suet Lim, Gelugor (MY); Stephen Christianson, Sherwood, OR (US); KiranKumar Kamisetty, Austin, TX (US); Rijo Kizhakkedathu Avarachan, Bayan Lepas (MY)

(73) Assignee: Intel Products IP LLC, Santa Clara, CA (US)

(21) Appl. No.: 19/718,743

(22) Filed: Jun. 24, 2026

Related U.S. Application Data
(60) Provisional application No. 63/929,697, filed on Dec. 2, 2025.

(51) Int. Cl. G06F 3/06

(52) U.S. Cl. CPC G06F 3/0629; G06F 3/0604; G06F 3/0673

(57) ABSTRACT

An example apparatus comprises a memory interface, a first portion of memory devices including first signal terminals wire bonded to the memory interface, and first power terminals not wire bonded to the memory interface, and a second portion of memory devices including second signal terminals not wire bonded to the memory interface, and second power terminals wire bonded to the memory interface.

### RELATED APPLICATION

This patent claims the benefit of U.S. Provisional Patent Application No. 63/929,697, which was filed on Dec. 2, 2025. U.S. Provisional Patent Application No. 63/929,697 is hereby incorporated herein by reference in its entirety. Priority to U.S. Provisional Patent Application No. 63/929,697 is hereby claimed.

### BACKGROUND

High-performance computing systems utilize large amounts of memory. Some computing systems utilize Package-on-Package (PoP) designs that facilitate stacking two or more memory circuits to improve memory density and performance.

### BRIEF DESCRIPTION OF THE DRAWINGS

FIG. 1 is a diagram of an example memory stack in accordance with the teachings herein.

FIG. 2 is a diagram depicting an example ball map of a memory device of the memory stack of FIG. 1.

FIG. 3 is a diagram depicting an example wire bonding implementation of the memory stack of FIG. 1 in accordance with the teachings herein.

FIG. 4 is a diagram depicting an example wire bonding implementation of the memory stack of FIG. 1 in accordance with the teachings herein.

FIG. 5 depicts an example implementation of the memory stacks of FIG. 1, further including passive components for power delivery.

FIG. 6 depicts an example on-board area of the memory stacks of FIG. 1.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Joint Electron Device Engineering Council (JEDEC) standard low power double data rate six (LPDDR6) memory has become the dominant interface for mobile, client, and high-performance computer platforms. The latest LPDDR 6 specification defines a 4-channel x96b package that is available in two primary form factors. First, a 14×14 millimeter (mm) package-on-package (POP) device and a 7×14 mm small-form-factor (SFF) device. Both packages utilize a 0.35 mm ball-pitch, with the POP device containing two x24b dies on one side of the die and two on the opposite side of the die, while the SFF device stacks all four x24b dies vertically on a single side.

In some applications (e.g., mobile applications), the SFF package is limited to a 16-die-stack (16H) height, which yields a maximum of 64 giga-byte (GB) per device (256 GB system memory). In high performance applications, (e.g., 512-GB total-capacity and above applications), designers can use the larger 14×14 mm POP device with a two-stack (2×16H) configuration. However, mobile-targeted POP devices typically are not designed beyond 16 die-stacks due to increased Z-height, signal-integrity challenges from longer wire-bond lengths, and thermal dissipation limits.

Beyond capacity, the 0.35 mm ball-pitch and the distributed, scattered power balls of the x96b packages impose routing constraints. Typical mainstream high-density interconnect (HDI) 3×3+ boards provide only two signal layers on the top stack, necessitating a transition to the bottom stack via a via-any-layer design. This transition inflates board cost and complexity, and many customers prefer to stay within the cheaper 3×3++ stack up, which is incompatible with the full x96b pin-map.

Known solutions do not address the dual requirements of enabling 512 GB total memory using the already-manufactured 7×14 mm SFF LPDDR 6 device and routing the device on a mainstream 3×3++ HDI board without incurring the cost of a via-any-layer design. Non-JEDEC custom dynamic random-access memory (DRAM) designs can provide the necessary capacity but require a new substrate layout and incur higher manufacturing risk. Consequently, designers are forced either to accept lower capacity or to adopt a more expensive board stack-up.

Examples described herein enable the transformation of a standard JEDEC-defined x96b LPDDR6 package into a functional x48 configuration that delivers double the memory capacity without the need for a new substrate or ball-map redesign. By re-mapping the wire-bond pads so that only one half of the four x24b channels is connected to input/output on the package side while the other half is wired to power, examples described herein enable a single 7×14 mm SFF x96 DRAM to supply 512 GB total capacity on a mainstream 3×3++ HDI board, achieving a reduction in board cost relative to a via-any-layer solution. Examples described herein partition the package's power and signal routes, freeing the under-unconnected ball area for more efficient routing, improving signal integrity, and shrinking the core area compared to a conventional 14×15 mm×48 device.

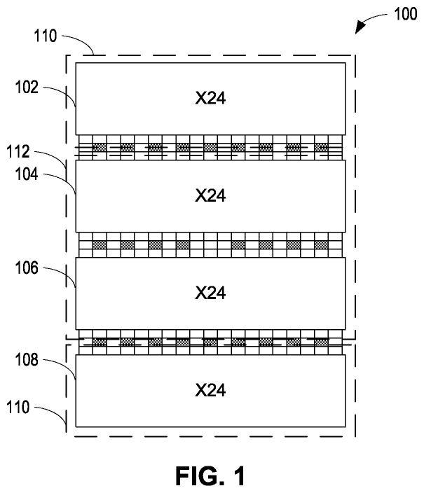

FIG. 1 depicts an example memory stack 100 constructed in accordance with the teachings herein. The example memory stack 100 includes a first memory device 102, a second memory device 104, a third memory device 106, and a fourth memory device 108. Each of the memory devices 102-108 are twenty-four-bit data width memory devices. Further, a height of the memory stack 100 is less than or equal to sixteen die stack. In some examples, the first memory device 102 and the fourth memory device 108 define a first portion of memory devices 110 and the second memory device 104 and the third memory device 106 define a second portion of memory devices 112.

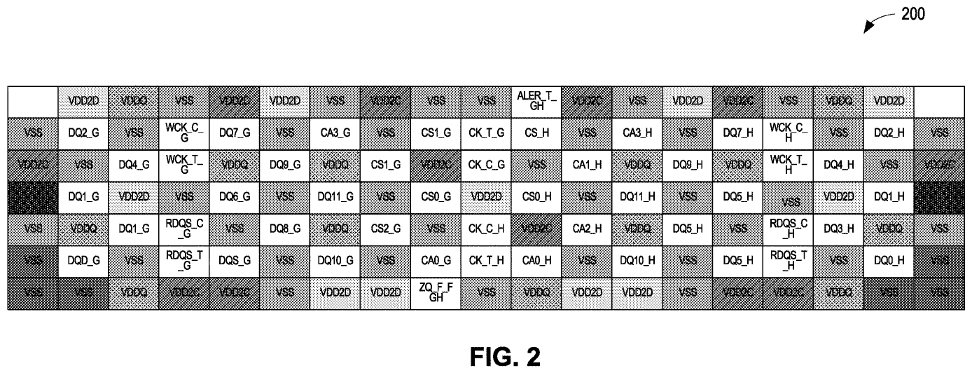

FIG. 2 depicts an example ball map 200 to implement the memory devices 102-108 of FIG. 1. The example ball map 200 includes a plurality of power balls, input and output balls (e.g., signal balls), and rank balls. The plurality of power balls, signal balls, and rank balls are distributed (e.g., scattered) across the ball map 200. In some examples, the ball map 200 has a 0.35 mm ball pitch. The 0.35 mm ball pitch can make wiring of the memory devices 102-108 to a memory interface relatively difficult.

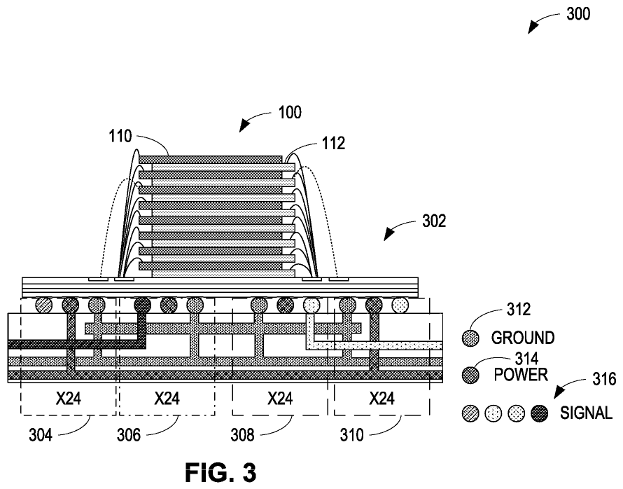

FIG. 3 depicts an example wire bonding implementation 300 of the memory stack 100 of FIG. 1. FIG. 3 includes the memory stack 100 including the first portion of memory devices 110 and the second portion of memory devices 112 and memory interface 302. The memory interface 302 includes a first channel 304, a second channel 306, a third channel 308, and a fourth channel 310. Where the channels 304-310 are associated with ones of the memory devices 102-108. Each of the memory channels 304-310 include a plurality of ground terminals 312 (e.g., interface ground terminals), power terminals 314 (e.g., interface power terminals), and signal terminals 316 (e.g., interface signal terminals). In the illustrated example, the first portion of memory devices 110 is associated with the second channel 306 and the third channel 308. Further, the second portion of memory devices 112 is associated with the first channel 304 and the fourth channel 310. In some examples, the memory interface 302 is a ninety-six-bit data width memory interface.

The first portion of memory devices 110 includes signal terminals wire bonded to the signal terminals 316 of the second channel 306 and the third channel 308. Further, the first portion of memory devices 110 includes power terminals that are not wire bonded to the power terminals 314 of the second channel 306 and the third channel 308. In the illustrated example, the first portion of memory devices 110 includes ground terminals wire bonded to the ground terminals 312 of the second channel 306 and the third channel 308. However, in other examples, the ground terminals of the first portion of memory devices 110 are not wire bonded to the ground terminals 312 of the second and third channels 306-308. Further, power terminals of the first portion of memory devices 110 are wire bonded to power terminals of the second portion of memory devices 112.

While the power terminals of the first portion of memory devices 110 are not directly coupled to the power terminals 312 of the second and third channels 306-308, the first portion of memory devices receive power from the second portion of memory devices. Not connecting the power terminals of the first portion of memory devices 110 enables routing associated with the memory interface 302 to be relatively simple. For example, wire bonding fewer terminals of the first portion of memory devices 110 to the memory interface 302 reduces complexity of the routing associated with the memory interface 302.

In some examples, the first portion of memory devices 110 includes rank terminals coupled to the signal terminals 316 of the second and third channels 306-308. For example, the rank terminals enable the memory interface to address specific memory devices 104-106 of the first portion of memory devices 110.

The second portion of memory devices 112 includes signal terminals not wire bonded to the signal terminals 316 of the first channel 304 and the fourth channel 310. Further, the second portion of memory devices 112 includes power terminals that are wire bonded to the power terminals 314 of the first channel 304 and the fourth channel 310. In the illustrated example, the second portion of memory devices 112 includes ground terminals wire bonded to the ground terminals 312 of the first channel 304 and the fourth channel 310. However, in other examples, the ground terminals of the second portion of memory devices 112 are not wire bonded to the ground terminals 312 of the first and fourth channels 304, 310. Further, signal terminals of the second portion of memory devices 112 are wire bonded to the signal terminals of the first portion of memory devices 110. In some examples, the second portion of memory devices 112 includes rank terminals coupled to the signal terminals 316 of the first and fourth channels 304, 310. For example, the rank terminals enable the memory interface to address specific memory devices 102, 108 of the second portion of memory devices 112.

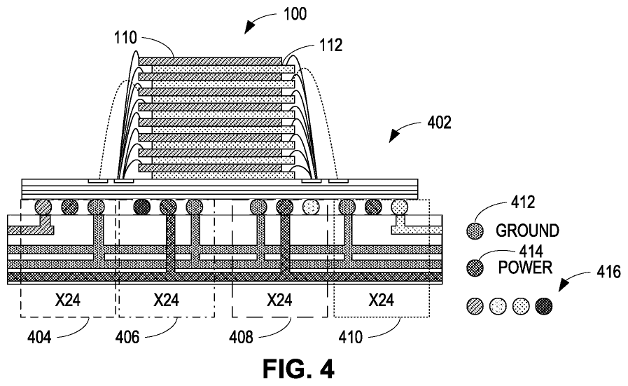

FIG. 4 depicts an alternative wire bonding implementation of the memory stack 100 of FIG. 1. FIG. 4 includes the memory stack 100 including the first portion of memory devices 110 and the second portion of memory devices 112 and memory interface 402. The memory interface 402 includes a first channel 404, a second channel 406, a third channel 408, and a fourth channel 410. Where ones of the channels 404-410 are associated with ones of the memory devices 102-108. Each of the memory channels 404-410 include a plurality of ground terminals 412, power terminals 414, and signal terminals 416. In the illustrated example, the first portion of memory devices 110 is associated with the second channel 406 and the third channel 408. Further, the second portion of memory devices 112 is associated with the first channel 404 and the fourth channel 410.

The first portion of memory devices 110 includes power terminals wire bonded to the power terminals 414 of the second channel 406 and the third channel 408. Further, the first portion of memory devices 110 includes signal terminals that are not wire bonded to the signal terminals 416 of the second channel 406 and the third channel 408. In the illustrated example, the first portion of memory devices 110 includes ground terminals wire bonded to the ground terminals 412 of the second channel 406 and the third channel 408. However, in other examples, the ground terminals of the first portion of memory devices 110 are not wire bonded to the ground terminals 412 of the second and third channels 406-408. Further, signal terminals of the first portion of memory devices 110 are wire bonded to signal terminals of the second portion of memory devices 112. In some examples, the first portion of memory devices 110 includes rank terminals coupled to the signal terminals 416 of the second and third channels 406-408. For example, the rank terminals enable the memory interface to address specific memory devices 104-106 of the first portion of memory devices 110.

The second portion of memory devices 112 includes signal terminals wire bonded to the signal terminals 416 of the first channel 404 and the fourth channel 410. Further, the second portion of memory devices 112 includes power terminals that are not wire bonded to the power terminals 414 of the first channel 404 and the fourth channel 410. In the illustrated example, the second portion of memory devices 112 includes ground terminals wire bonded to the ground terminals 412 of the first channel 404 and the fourth channel 410. However, in other examples, the ground terminals of the second portion of memory devices 112 are not wire bonded to the ground terminals 412 of the first and fourth channels 404, 410. Further, signal terminals of the second portion of memory devices 112 are wire bonded to the signal terminals of the first portion of memory devices 110. In some examples, the second portion of memory devices 112 includes rank terminals coupled to the signal terminals 416 of the first and fourth channels 404, 410. For example, the rank terminals enable the memory interface 402 to address specific memory devices 102, 108 of the second portion of memory devices 112.

While the power terminals of the second portion of memory devices 112 are not directly coupled to the power terminals 412 of the first and fourth channels 404, 410 the second portion of memory devices 112 receive power from the first portion of memory devices 110. Not connecting the power terminals of the second portion of memory devices 112 enables routing associated with the memory interface 302 to be relatively simple. For example, wire bonding fewer terminals of the second portion of memory devices 112 to the memory interface 402 reduces complexity of the routing associated with the memory interface 402.

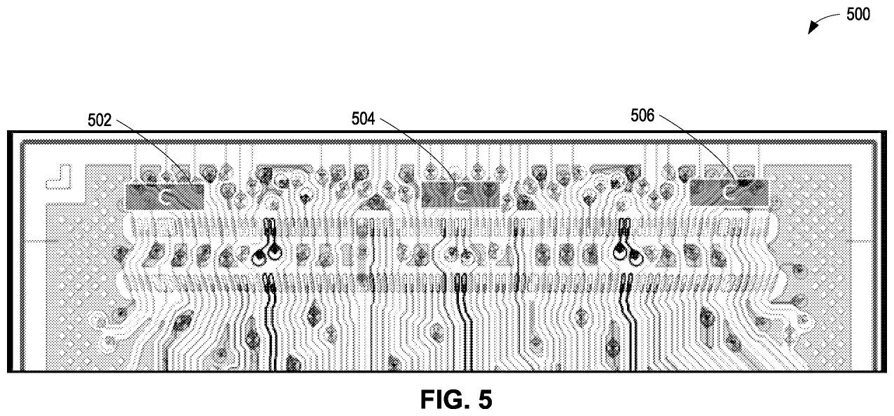

FIG. 5 shows an additional implementation of a memory interface 500 that can implement the memory interfaces 302, 402 of FIGS. 3 and 4, where passive components 502-506 are integrated into the memory interface 500 at the unconnected (e.g., wire bond free channels) to improve power delivery. For example, the passive components 502-506 can include capacitors to filter power delivered to the memory stack 100.

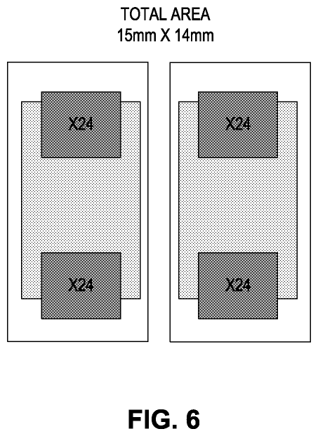

FIG. 6 shows an example on-board area associated with the memory stack 100 of FIG. 1. FIG. 6 shows that the memory stack 100 can be implemented within a 15 mm by 14 mm area. The existing package on package (POP) solution described above, with only two memory devices, has an on-board area of 14 mm by 14 mm. Examples described herein enable four memory devices in a slightly larger area. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods for memory configuration have been disclosed. The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent. Further examples and combinations thereof include the following:
Example 1 includes an apparatus comprising a memory interface, a first portion of memory devices including first signal terminals wire bonded to the memory interface, and first power terminals not wire bonded to the memory interface, and a second portion of memory devices including second signal terminals not wire bonded to the memory interface, and second power terminals wire bonded to the memory interface.
Example 2 includes the apparatus of any preceding clause, wherein the first power terminals are wire bonded to the second portion of memory devices.
Example 3 includes the apparatus of any preceding clause, wherein the second signal terminals are wire bonded to the first portion of memory devices.
Example 4 includes the apparatus of any preceding clause, wherein the second portion of memory devices include a rank terminal wire bonded to the memory interface.
Example 5 includes the apparatus of any preceding clause, wherein the first portion of memory devices include first ground terminals wire bonded to the second portion of memory devices.
Example 6 includes the apparatus of any preceding clause, wherein the second portion of memory devices includes second ground terminals wire bonded to the memory interface.
Example 7 includes the apparatus of any preceding clause, wherein memory devices of the first portion of memory devices and the second portion of memory devices are twenty-four-bit data width memory devices.
Example 8 includes the apparatus of any preceding clause, wherein the memory interface is a ninety-six-bit data width memory interface.
Example 9 includes a system comprising a memory interface including a plurality of channels, where each channel includes at least an interface signal terminal and an interface power terminal, a first portion of memory devices including first signal terminals wire bonded to a first interface signal terminal of a first channel of the plurality of channels, and first power terminals, and a second portion of memory devices including second signal terminals wire bonded to the first signal terminals, and second power terminals wire bonded to the first power terminals and a second interface power terminal of a second channel of the plurality of channels.
Example 10 includes the system of any preceding clause, wherein the second portion of memory devices include a rank terminal wire bonded to the memory interface.
Example 11 includes the system of any preceding clause, wherein the first portion of memory devices include first ground terminals wire bonded to the second portion of memory devices.
Example 12 includes the system of any preceding clause, wherein each channel of the plurality of channels further includes an interface ground terminal and the second portion of memory devices include second ground terminals wire bonded to a second ground interface of the second channel.
Example 13 includes the system of any preceding clause, wherein memory devices of the first portion of memory devices and the second portion of memory devices are twenty-four-bit data width memory devices.
Example 14 includes the system of any preceding clause, wherein the memory interface is a ninety-six-bit data width memory interface.
Example 15 includes a method comprising wire bonding first signal terminals of a first portion of memory devices to a memory interface, not wire bonding first power terminals of the first portion of memory devices to the memory interface, not wire bonding second signal terminals of a second portion of memory devices to the memory interface, and wire bonding second signal terminals of the second portion of memory devices to the memory interface.
Example 16 includes the method of any preceding clause, further including wire bonding the first power terminals to the second portion of memory devices.
Example 17 includes the method of any preceding clause, further including wire bonding the second signal terminals to the first portion of memory devices.
Example 18 includes the method of any preceding clause, further including wire bonding a rank terminal of the second portion of memory devices to the memory interface.
Example 19 includes the method of any preceding clause, further including wire bonding first ground terminals of the first portion of memory devices to the second portion of memory devices.
Example 20 includes the method of any preceding clause, further including wire bonding second ground terminals of the second portion of memory devices to the memory interface.

What is claimed is:

1. An apparatus comprising:
a memory interface;
a first portion of memory devices including:
first signal terminals wire bonded to the memory interface; and
first power terminals not wire bonded to the memory interface; and
a second portion of memory devices including:
second signal terminals not wire bonded to the memory interface; and
second power terminals wire bonded to the memory interface.

2. The apparatus of claim 1, wherein the first power terminals are wire bonded to the second portion of memory devices.

3. The apparatus of claim 1, wherein the second signal terminals are wire bonded to the first portion of memory devices.

4. The apparatus of claim 1, wherein the second portion of memory devices include a rank terminal wire bonded to the memory interface.

5. The apparatus of claim 1, wherein the first portion of memory devices include first ground terminals wire bonded to the second portion of memory devices.

6. The apparatus of claim 5, wherein the second portion of memory devices includes second ground terminals wire bonded to the memory interface.

7. The apparatus of claim 1, wherein memory devices of the first portion of memory devices and the second portion of memory devices are twenty-four-bit data width memory devices.

8. The apparatus of claim 7, wherein the memory interface is a ninety-six-bit data width memory interface.

9. A system comprising:
a memory interface including a plurality of channels, where each channel includes at least an interface signal terminal and an interface power terminal;
a first portion of memory devices including:
first signal terminals wire bonded to a first interface signal terminal of a first channel of the plurality of channels; and
first power terminals; and
a second portion of memory devices including:
second signal terminals wire bonded to the first signal terminals; and
second power terminals wire bonded to the first power terminals and a second interface power terminal of a second channel of the plurality of channels.

10. The system of claim 9, wherein the second portion of memory devices include a rank terminal wire bonded to the memory interface.

11. The system of claim 9, wherein the first portion of memory devices include first ground terminals wire bonded to the second portion of memory devices.

12. The system of claim 11, wherein each channel of the plurality of channels further includes an interface ground terminal and the second portion of memory devices include second ground terminals wire bonded to a second ground interface of the second channel.

13. The system of claim 9, wherein memory devices of the first portion of memory devices and the second portion of memory devices are twenty-four-bit data width memory devices.

14. The system of claim 9, wherein the memory interface is a ninety-six-bit data width memory interface.

15. A method comprising:
wire bonding first signal terminals of a first portion of memory devices to a memory interface;
not wire bonding first power terminals of the first portion of memory devices to the memory interface;
not wire bonding second signal terminals of a second portion of memory devices to the memory interface; and
wire bonding second power terminals of the second portion of memory devices to the memory interface.

16. The method of claim 15, further including wire bonding the first power terminals to the second portion of memory devices.

17. The method of claim 15, further including wire bonding the second signal terminals to the first portion of memory devices.

18. The method of claim 15, further including wire bonding a rank terminal of the second portion of memory devices to the memory interface.

19. The method of claim 15, further including wire bonding first ground terminals of the first portion of memory devices to the second portion of memory devices.

20. The method of claim 19, further including wire bonding second ground terminals of the second portion of memory devices to the memory interface.
